(19) United States
(12) Patent Application Publication
(10) Pub. No.: US 2024/0348629 A1
(43) Pub. Date: Oct. 17, 2024

(54) System and Method for Automatically Associating Cybersecutiry Intelligence to Cyberthreat Actors

(71) Applicant: Google LLC, Mountain View, CA (US)

(72) Inventors: Matthew Berninger, Denver, CO (US); Barry Vengerik, Montclair, NJ (US)

(21) Appl. No.: 18/757,257

(22) Filed: Jun. 27, 2024

Related U.S. Application Data
(63) Continuation of application No. 17/676,755, filed on Feb. 21, 2022, now Pat. No. 12,063,229.
Application No. 17/676,755 is a continuation of application No. 16/450,579, filed on Jun. 24, 2019, now Pat. No. 11,258,806.

(51) Int. Cl. H04L 9/40; G06F 18/213; G06N 20/00

(52) U.S. Cl. CPC H04L 63/1416; G06F 18/213; G06N 20/00; H04L 63/102; H04L 63/1441

(57) ABSTRACT

A computerized method for associating cyberthreat actor groups responsible for different cyberthreats is described. The method involves generating a similarity matrix based on content from received clusters of cybersecurity information. Each received cluster of cybersecurity information is assumed to be associated with a cyberthreat. The similarity matrix is composed via an optimized equation combining separate similarity metrics, where each similarity metric of the plurality of similarity metrics represents a level of correlation between at least two clusters of cybersecurity information, with respect to a particular aspect of operations described in the clusters. The method further involves that, in response to queries directed to the similarity matrix, generating a listing of a subset of the clusters of cybersecurity information having a greater likelihood of being associated with cyberthreats caused by the same cyberthreat actor group.

### CROSS-REFERENCES TO RELATED APPLICATIONS

The present application is a continuation of U.S. application Ser. No. 17/676,755 having a filing date of Feb. 21, 2022, which is a continuation of U.S. patent application Ser. No. 16/450,579, filed Jun. 24, 2019, now U.S. Pat. No. 11,258,806, issued Feb. 22, 2022, the entire contents of which are incorporated by reference herein. Applicant claims priority to and the benefit of each of such applications and incorporate all such applications herein by reference in its entirety.

### FIELD

Embodiments of the disclosure relate to the field of cybersecurity. More specifically, one embodiment of the disclosure relates to a cyberthreat analysis system that is configured to automatically analyze and associate cyberthreats, and in particular cybersecurity intelligence representative of the cyberthreats, with existing or new cyberthreat actor groups.

### GENERAL BACKGROUND

Cybersecurity threats (referred to as “cyberthreats”) have become a pervasive problem for organizations as many networked devices and other resources have been subjected to attack and compromised. A cyberthreat constitutes an actual cyberattack on or a potential threat to the security of stored or in-transit data or of IT infrastructure produced or propagated by a cyberthreat actor group. For example, a cyberthreat may involve a cyberattack directed to the infiltration of content onto a network device, where the content may be a type of executable such as software that is intended to perpetrate malicious or criminal activity. Alternatively, the cyberthreat may involve malicious activities conducted by the cyberthreat actor group, without placement of malicious content onto the network device, in order to harm or co-opt operations of that network device or exfiltrate sensitive information from the network.

A “cyberthreat actor group” may include an individual cyberthreat actor or multiple (e.g., two or more) cyberthreat actors, where a “cyberthreat actor” is generally considered to be a person or entity operating as a nation-state attacker or a financially motivated attacker. The investigations conducted on each cyberthreat may uncover information that indicate activities, infrastructure, and/or malware that may be part of an intrusion, campaign, or other series of related actions that constitute a cyberattack. Identifying cyberthreat actor groups from this information has been extremely challenging due to the large amount of information that must be evaluated in order to identify a cyberthreat actor group with a high level of confidence. Additionally, the difficulty of discovering and investigating potential associations between cyberthreat actor groups responsible for different cyberthreats has increased as the amount of information to evaluate has increased.

Each year, a vast amount of cybersecurity intelligence is gathered by cybersecurity service providers based on hundreds of investigations and thousands of hours of analytics. The cybersecurity intelligence includes content pertaining to investigated cyberthreats, cyberthreats still under investigation, or a combination thereof. The cybersecurity intelligence may be provided from a number of sources. Currently, this cybersecurity intelligence is analyzed manually by expert human analysts in an attempt to identify cyberthreat actor groups, as each cyberthreat actor group tends to be associated with certain distinct characteristics. Besides the short supply of expert human analysts, this manual identification process is labor and time intensive, as human analysts may take days or weeks before she or he can associate a cluster of cybersecurity intelligence to a particular cyberthreat actor group. Therefore, as the amounts of cybersecurity intelligence (e.g., data about attacker activities) increases, this manual identification scheme does not scale in identifying cyberthreat actors and defending against new attempted cyberattacks.

### BRIEF DESCRIPTION OF THE DRAWINGS

Embodiments of the invention are illustrated by way of example and not by way of limitation in the figures of the accompanying drawings, in which like references indicate similar elements and in which:

FIG. 1 is an exemplary block diagram of an exemplary embodiment of a cyberthreat actor identification platform including a data store and a cyberthreat analysis system.

FIG. 2 is an exemplary block diagram of the data store of FIG. 1 communicatively coupled to cybersecurity intelligence resources.

FIG. 3 is an exemplary block diagram of a profile maintained within the data store of FIG. 1.

FIG. 4A is an exemplary block diagram of an operational flow for model generation and usage by the cyberthreat analysis system of FIG. 1.

FIG. 4B is an exemplary block diagram of a model generation subsystem communicatively coupled to a model application subsystem deployed within the cyberthreat analysis system of FIG. 4A.

FIGS. 5A-5B are exemplary block diagrams of a logical architecture of the cyberthreat analysis system of FIG. 1.

FIG. 5C is an exemplary diagram operability of a first analytic (TD_IDF) conducted by the cyberthreat analytic logic operating within the cyberthreat analysis system of FIG. 1.

FIG. 5D is an exemplary diagram operability of a second analytic (Cosine Similarity) conducted by the cyberthreat analytic logic operating within the cyberthreat analysis system of FIG. 1.

FIG. 6A-6B are exemplary block diagrams collectively illustrating an operational flow of the cyberthreat analysis system of FIG. 5A.

### DETAILED DESCRIPTION

Embodiments of the present disclosure generally relate to a cybersecurity threat (cyberthreat) analysis system, operating in accordance with a machine learning-based model, which conducts analytics on content from received cybersecurity intelligence to determine whether the received cybersecurity intelligence can be associated with existing cyberthreat actor groups. Such analytics is conducted to automate presentation of potential associations between unknown and known cyberthreat actor groups to provide greater efficiency in the use of analysts' time. Herein, the cyberthreat analysis system is adapted to utilize the machine learning-based model that optimizes a final modeling step by combining separate similarity values into a single similarity metric, using weightings (coefficients) learned from the machine learning-based model trained on the sampled, test profiles (datasets).

To achieve greater efficiency, a collection of forensically-related indicia (e.g., text consisting of characters, numbers and/or symbols; images, etc.) is obtained from each cluster of cybersecurity intelligence that is associated with a particular cyberthreat. Each indicium constitutes salient information pertaining to a particular type of content within a cybersecurity intelligence cluster (e.g., a malware name, an attacker alias, etc.) and the frequency of occurrence of such information within a cybersecurity intelligence cluster (e.g., a count representing a number of occurrences, etc.).

The forensically-related indicia may be maintained as part of a structured representation of that cybersecurity intelligence cluster, namely a predetermined data structure referred to as a “profile.” Within each profile, related indicia may be grouped by category (i.e., indicia within the same category are grouped together). As an illustrative example, the forensically-related indicia may include tactic, technique, and procedure (“TTP”) information, and thus, the profile may be structured to support a plurality of categories including, but not limited or restricted to the following categories: (i) known aliases, (ii) malware names, (iii) methods of installation and/or operation for the malware, (iv) targeted industries, (v) targeted countries, or (vi) infrastructure. A profile may be labeled “uncategorized” when the cyberthreat actor group, which is responsible for a cyberthreat to which the cyberthreat intelligence cluster is directed, has not been confirmed. Additionally, a profile may be labeled with a designation for a known cyberthreat actor group upon confirming that the known cyberthreat actor group is responsible for the cyberthreat summarized by the profile (referred to as a “categorized” profile).

Thereafter, in response to a triggering event (e.g., time-based trigger, change in a profile or predetermined number or percentage of profiles, etc.), the machine learning-based model may be updated by conducting analytics on the indicia included within the profiles in order to uncover connections between the actor group responsible for a cyberthreat (as identified by a corresponding cybersecurity intelligence cluster and represented by the profile) and any existing cyberthreat actor groups. Although, as an alternative embodiment, the machine learning-based model may be configured to conduct analytics on larger datasets than the profiles.

More specifically, according to one embodiment of the disclosure, the cybersecurity intelligence may be received from one or more network devices operating as cybersecurity intelligence resource(s) and are stored within a data store. A portion of the cybersecurity intelligence (referred to as a “cybersecurity intelligence cluster”) may include content associated with one or more investigations that, over time, may increase in size, especially when the cybersecurity intelligence cluster is associated with an ongoing campaign. As a result, a profile is generated to maintain forensically-related indicia associated with each cybersecurity intelligence cluster and the number of occurrences of each indicium. The categories for indicia to be included in the profiles are determined by analysts as content within cybersecurity intelligence that provides more assistance in identifying cyberthreat actor groups responsible for cyberthreats than other content.

As described below, operating in accordance with the machine learning-based model, the cyberthreat analysis system conducts a multi-step analysis on content within the profiles to determine levels of correlation between the cybersecurity intelligence clusters associated with each of these profiles. For clarity, the operations of the multi-step analysis will be described for a single (first) profile that represents a particular cybersecurity intelligence cluster, albeit these operations may be performed iteratively on the entire corpus of profiles representing the received cybersecurity intelligence. The multi-step analysis is conducted to identify profiles within the corpus of profiles that have similar indicia and/or a determined a level of correlation, and as a result, identifies the cyberthreats represented by these profiles that may have been perpetrated by the same cyberthreat actor group or related cyberthreat actor groups.

For this embodiment of the disclosure, the multi-step analysis involves a first analytic conducted on indicia maintained in each profile category to produce feature vectors for each category. Each feature vector is configured to represent the distinctiveness of indicium within its category. For instance, as an illustrative example, the first analytic may convert each indicium (e.g., term), represented in a first format (e.g., text consisting of characters, numbers and/or symbols) and maintained in a first category of the first profile, into a result having a second format. The result represents the distinctiveness of that term within the first category as well as across the entire corpus of profiles accessible to the cyberthreat analysis system. As an example, the second format may constitute a value within a first prescribed range, where a higher value within the first prescribed range may represent the indicium is more distinctive and better representative content for the cybersecurity intelligence cluster.

Collectively, the results of the first analytic form a feature vector for the first category. Stated differently, where a category of the first profile has a total of “M” distinct terms (where M≥1), the feature vector for that category-profile combination is now represented as a M-dimensional feature vector. The first analytic is repetitive for each category within the first profile so that a feature vector is generated for each category of the first profile.

Additionally, a second analytic of the multi-step analysis is conducted between the feature vectors associated with each category of the first profile to feature vectors associated with corresponding categories from the other profiles within the corpus of profiles, which may include other “categorized” profiles and/or “uncategorized” profiles. The second analytic is conducted to determine a level of correlation (similarity value) between categories of different profiles, such as the first profile and any categorized or uncategorized profiles within the stored corpus of profiles. This “similarity value” may be represented by a value within a second prescribed range, where a higher value within the second prescribed range represents a higher correlation between features maintained within a specific category. The second analytic is further configured to generate a similarity vector (i.e., a collection of multiple similarity values between the first profile and another profile within the corpus of profiles).

Thereafter, the similarity vector is translated into a single similarity metric, where the above-described operations are conducted iteratively for all of the profiles to form an aggregate of similarity metrics. This aggregate, sometimes referred to as a “similarity matrix,” allows an analyst to accurately determine through the generation of displayable or printable results, in real-time, the similarity between at least two profiles such as a reference profile (e.g., the first profile) and one of more other profiles within the corpus of profiles, for example. The displayable or printable results may be presented at a remote or local analyst workstation or console or later included in a variety of displayable or printable (hardcopy) reports. Moreover, the similarity matrix represents levels of correlation between cyberthreat actor groups that are responsible for the cybersecurity intelligence clusters associated with these profiles.

To improve performance, a weighting may be applied to some or all of the similarity values forming the similarity vectors in producing the similarity metric. The weighting is conducted to alter the relevance of certain indicia categories in identifying cyberthreat actor group responsibility based on changes in the threat landscape. Also, by maintaining the results from the first and second analytics, the cyberthreat analysis system may provide visibility as to the level of correlation between features within the profiles being compared as evidence for the conclusions reached by the machine learning-based model.

For instance, based on this determination, the cyberthreat analysis system may be configured to merge together multiple cybersecurity intelligence clusters that appear to be from the same unidentified cyberthreat actor group and update the profile associated with that merged cybersecurity intelligence cluster. Additionally, or in the alternative, the cyberthreat analysis system may be configured to alter the labeling of an uncategorized profile to now represent a new cyberthreat actor group or merge together multiple cybersecurity intelligence clusters that appear to involve the same identified cyberthreat actor group and update the categorized profile with content from the uncategorized profile.

Without a cyberthreat actor identification platform, described below, which analyzes and associates intelligence uncovered during an investigation to identify the cyberthreat actor group associated with the investigation, the number of uncategorized intelligence clusters will increase over time to a level in which they start to become a hindrance or distraction in continued efforts to identify cyberthreat actor groups.

According to one embodiment of the disclosure, the cyberthreat actor identification platform includes a data store and a cyberthreat analysis system. In general, the data store maintains cybersecurity intelligence, where each cybersecurity intelligence cluster may include information directed to an analysis of a cyberthreat (and/or multiple related cyberthreats) by a cybersecurity investigator (e.g., cybersecurity appliance, incident response team, cybersecurity expert, etc.). As an example, a cybersecurity intelligence cluster may include one or more incident response reports that describe the activity associated with a potential breach (e.g., malware type, activity, alias of cyberthreat actor group, targeted company and its industry, network (IP) address for downloaded malware, etc.). As another example, a cybersecurity intelligence cluster may include information associated with a prior analysis of malware or information associated with review of the current threat landscape as offered by cybersecurity investigators, such as observed campaigns or current cyberattack trends for example. The data store may be periodically or extemporaneously updated with cybersecurity intelligence.

The cybersecurity intelligence clusters associated with a particular cyberthreat may be relied upon to generate a profile. As one embodiment, the profile may be constructed to maintain indicia associated with different categories, namely different types of content that are considered to be helpful in determining cyberthreat actor groups. As an illustrative example, the profile may include multiple categories such as (i) actor alias, (ii) malware name (for detected malware belonging to the cyberattack), (iii) methods of installation and/or operation (e.g. spearfishing, powershell, etc.) for detected malware, (iv) targeted industries (e.g., governmental, military, energy, semiconductor, etc.), (v) targeted countries (United States, England, France, etc.), and/or (vi) infrastructure (e.g., communicative information such as Internet Protocol “IP” address, Media Access Control “MAC’ address, host address, etc.). The data store is configured to maintain a corpus of profiles, including uncategorized profiles and/or categorized profiles.

According to one embodiment of the disclosure, the cyberthreat analysis system includes a processor and memory, which is configured to store logic for execution by the processor. Examples of the stored logic may include, but is not limited or restricted to model generation subsystem, model application subsystem and reporting subsystem. The model application subsystem further includes content aggregation logic, cyberthreat analytic logic and model optimization logic, as described below.

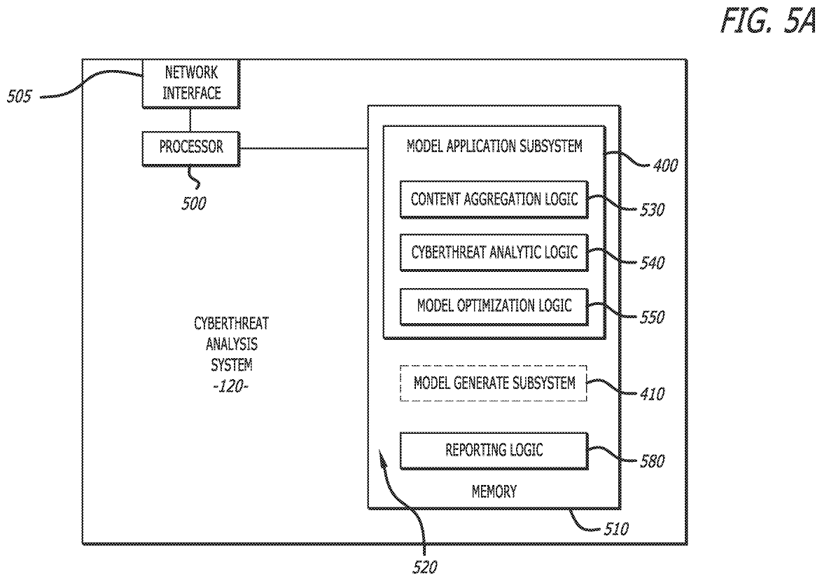

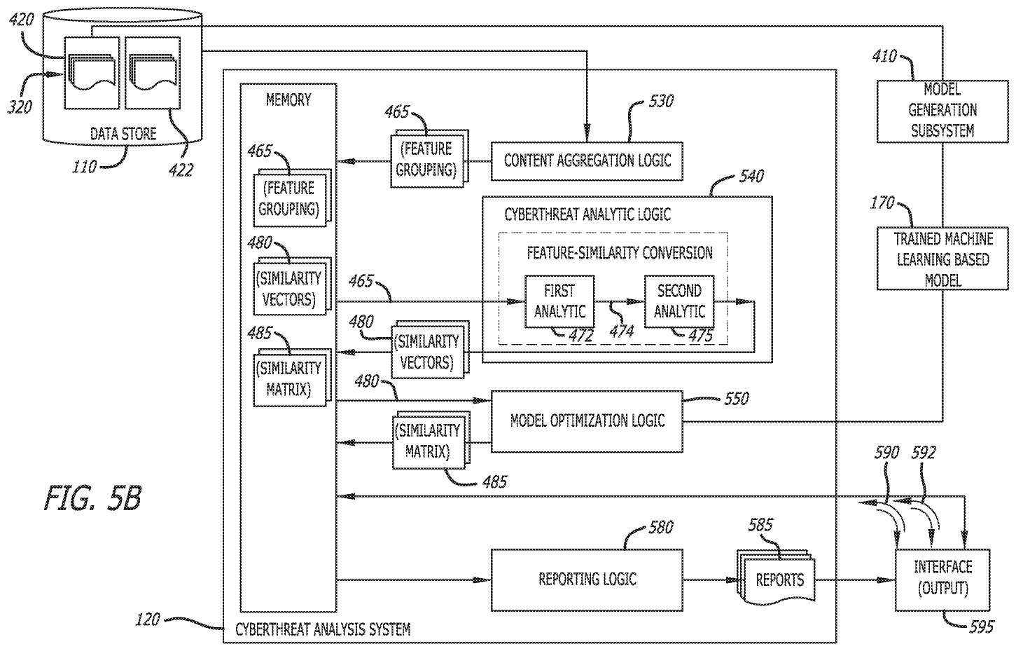

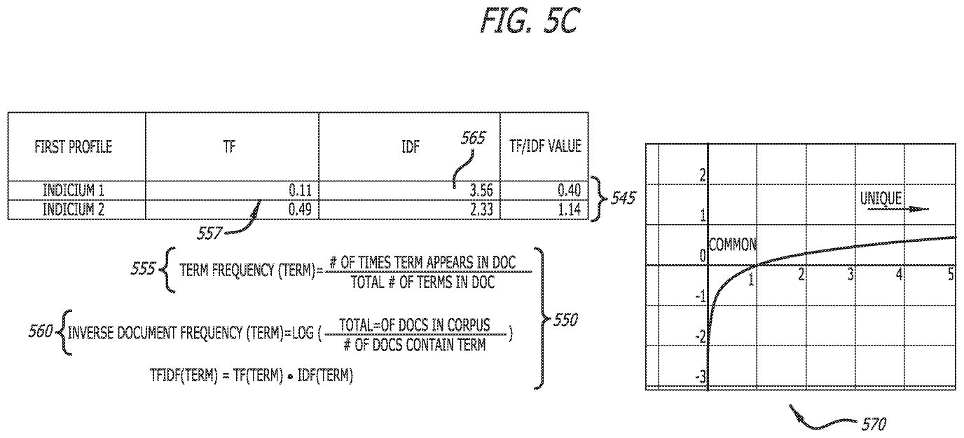

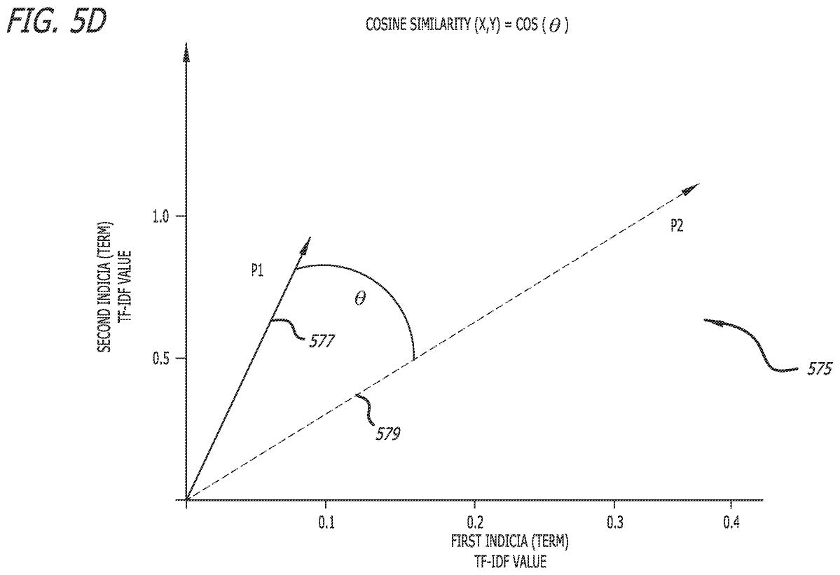

Herein, according to this embodiment, the model generation subsystem is configured to generate a machine learning-based model supplied to the model application subsystem. The model application subsystem is configured to apply the model to the stored cybersecurity intelligence, namely the corpus of profiles, to evaluate similarities between the stored cybersecurity intelligence. The similarities provide guidance to analysts toward identifying cyberthreat actor groups involved in different cyberthreats as represented by the received cybersecurity intelligence clusters. In particular, for this embodiment, the model is configured to convert content within the corpus of profiles into the similarity matrix (described above), which may be queried by analysts to receive a ranking of profiles than are most similar (i.e., indicia suggests highest potential of the cyberthreat associated with the profile as originating from the same or related cyberthreat actor group). This conversion is accomplished in accordance with the multi-step analysis described herein and illustrated in FIGS. 5A-7.

More specifically, the model generation subsystem is configured to generate a model by analyzing the contents of the data store. In some embodiments, the model generation subsystem accesses a first portion of content maintained within the data store to generate a model and a second portion of content maintained within the data store to verify the generated model. In particular, the model generation subsystem is configured to receive information regarding known cyberthreats (e.g., forensically-related indicia sampled from multiple “categorized” profiles stored within the data store. There is then a sampling of these profiles to produce a number of smaller test profiles (sometimes referred to as “test datasets). According to one embodiment of the disclosure, these test profiles are then processed through the cyberthreat analytic logic described above to create a ‘test’ similarity matrix, in which some pairs of test profiles are known to be related, and others are known to not be related.

Based on these test profiles, the model may be “tuned” by the model generation subsystem to improve operation by confirming that certain test profiles associated with forensically-related indicia procured from a particular profile, and thus pertaining to a particular known cyberthreat actor group, is determined by the model to be correlated to that known cyberthreat actor group. The tuning may be accomplished by applying the (labeled) test profiles to the model, and through machine learning inference logic (e.g., linear regression or other regression schemes), the weightings to be applied to the similarity metrics is “learned” to improve the accuracy of the model in identifying correct categorized profile associated with the test profiles.

The model application subsystem receives the model generated by the model generation subsystem and applies the corpus of profiles, including the content associated with the “uncategorized” profiles. In particular, the content aggregation logic of the model application subsystem is configured to access information regarding the corpus of profiles (e.g., forensically-related indicia maintained in “categorized” profiles and “uncategorized” profiles) and separate forensically-related indicia associated with each category of the profiles for subsequent processing by the cyberthreat analytic logic. As a result, where each profile is segmented into “N” categories (N≥1, e.g., N=6), the content aggregation logic produces “N” feature groupings of forensically-related indicia, where each “feature grouping” corresponding to a particular category.

Thereafter, the cyberthreat analytic logic is configured to conduct the multi-step analysis on content within the profiles to determine levels of correlation between the cybersecurity intelligence clusters associated with each of these profiles. The multi-step analysis involves a first analytic that is conducted on the first portion of content, namely the forensically-related indicia associated with the “N” categories, to produce “N” feature vectors. Each feature vector includes values associated with each indicium within that profile category. According to one embodiment of the disclosure, each value is generated based on a Term Frequency-Inverse Document Frequency (TF-IDF) conversion technique (described below) to determine which indicia are more important to a determination of a cyberthreat actor group than other indicia. Also, it is contemplated that each cyberthreat actor group and category may be generally represented as a feature vector (or, more generally, a data structure) containing feature scores. Other embodiments for the first analytic may include alternative ranking analysis systems to accomplish similar feature scores.

The cyberthreat analytic logic is further configured to conduct a second analytic on combinations of feature vectors to determine the difference between cyberthreat actor groups. In some embodiments, feature vector similarity may be determined using, for example, Cosine Similarity (described below). Stated differently, the cyberthreat analytic logic is configured to conduct the second analytic on the feature vectors to determine a level of correlation between feature vectors representing categories of different profiles. The level of correlation may be represented by a particular feature score (i.e., similarity value) within the second prescribed range, where a feature score towards the ends of this range identifies higher/lower levels of correlation (e.g., increased/decreased similarity). These similarity values, collectively operating as a similarity vector, may be subsequently used to determine a level of correlation between an identified, cyberthreat actor group associated with a reference profile and one or more cyberthreat actor groups among a corpus of profiles.

Thereafter, the model optimization logic is configured to convert the similarity vectors into the similarity matrix, as described above. According to one embodiment of the disclosure, the model optimization logic may allow for the alteration of the weighting for each of the similarity values, without changes to other model functionality.

Additionally, the model application subsystem further receives information pertaining to an association between a previously uncategorized, cyberthreat actor group and another cyberthreat actor group in order to effectuate a merge (or combination) of cybersecurity intelligence for both actor groups. Based on the merging of the information, the model is regenerated for application to newly received information.

The reporting logic receives information associated with merged cyberthreat actor groups and generates reports (e.g., organized information directed to a “merge” operation or signaling, such as an alert, with information to access the organized information) for further investigation by cyberthreat analysts and/or for alerting cybersecurity investigators and/or administrators. In some embodiments, cybersecurity investigators may receive information associated with newly merged cyberthreat actor groups to assess network and system vulnerability associated with that cyberthreat actor group.

In some embodiments of the invention, the cyberthreat analysis system operating as an analytic tool may be advantageously used by a cybersecurity analyst to aid in the targeted analysis of an unknown cyberthreat actor group to determine if it is part of a particular known cyberthreat actor group.

### I. Terminology

In the following description, certain terminology is used to describe aspects of the invention. In certain situations, the terms “logic” and “subsystem” are representative of hardware, firmware, and/or software that is configured to perform one or more functions. As hardware, the logic (or subsystem) may include circuitry having data processing and/or storage functionality. Examples of such circuitry may include, but are not limited or restricted to a processor, a programmable gate array, a microcontroller, an application specific integrated circuit, wireless receiver, transmitter and/or transceiver circuitry, semiconductor memory, or combinatorial logic.

Alternatively, or in combination with hardware circuitry, the logic (or subsystem) may be software in the form of one or more software modules. The software modules may include an executable application, a daemon application, an application programming interface (API), a subroutine, a function, a procedure, an applet, a servlet, a routine, source code, a shared library/dynamic load library, or even one or more instructions. The software module(s) may be stored in any type of a suitable non-transitory storage medium, or transitory storage medium (e.g., electrical, optical, acoustical or other form of propagated signals such as carrier waves, infrared signals, or digital signals). Examples of non-transitory storage medium may include, but are not limited or restricted to a programmable circuit; a semiconductor memory; non-persistent storage such as volatile memory (e.g., any type of random access memory “RAM”); persistent storage such as non-volatile memory (e.g., read-only memory “ROM”, power-backed RAM, flash memory, phase-change memory, etc.), a solid-state drive, hard disk drive, an optical disc drive, or a portable memory device. As firmware, the logic (or subsystem) may be stored in persistent storage.

The term “network device” should be generally construed as physical logic (electronics) or virtualized logic with data processing capability and/or a capability of connecting to any type of network, such as a public network (e.g., internet), a private network (e.g., any type of local area network), a public cloud network (e.g., Amazon Web Service (AWS®), Microsoft Azure®, Google Cloud®, etc.), or a private cloud network. Examples of a network device may include, but are not limited or restricted to, any of the following: a server; a mainframe; a firewall; a data transfer device (e.g., intermediary communication device, router, repeater, portable mobile hotspot, etc.); an endpoint device (e.g., a laptop, a smartphone, a tablet, a desktop computer, a netbook, gaming console, etc.); or a virtual device being software that supports data capture, preliminary analysis of meta-information associated with cybersecurity intelligence.

The term “message” generally refers to signaling (wired or wireless) as either information placed in a prescribed format and transmitted in accordance with a suitable delivery protocol or information made accessible through a logical data structure such as an API. Examples of the delivery protocol include, but are not limited or restricted to HTTP (Hypertext Transfer Protocol); HTTPS (HTTP Secure); Simple Mail Transfer Protocol (SMTP); File Transfer Protocol (FTP); iMESSAGE; Instant Message Access Protocol (IMAP); or the like. Hence, each message may be in the form of one or more packets, frames, or any other series of bits having the prescribed, structured format.

The term “computerized” generally represents that any corresponding operations are conducted by hardware in combination with software and/or firmware.

The term “transmission medium” generally refers to a physical or logical communication link (or path) between two or more network devices. For instance, as a physical communication path, wired and/or wireless interconnects in the form of electrical wiring, optical fiber, cable, bus trace, or a wireless channel using infrared, radio frequency (RF), may be used.

In certain instances, the terms “compare,” comparing,” “comparison,” or other tenses thereof generally mean determining if a match (e.g., identical or a prescribed level of correlation) is achieved between two items where one of the items may include content within meta-information associated with the feature.

Finally, the terms “or” and “and/or” as used herein are to be interpreted as inclusive or meaning any one or any combination. As an example, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure is to be considered as an example of the principles of the invention and not intended to limit the invention to the specific embodiments shown and described.

### II. General Architecture

### A. Cyberthreat Actor Identification Platform

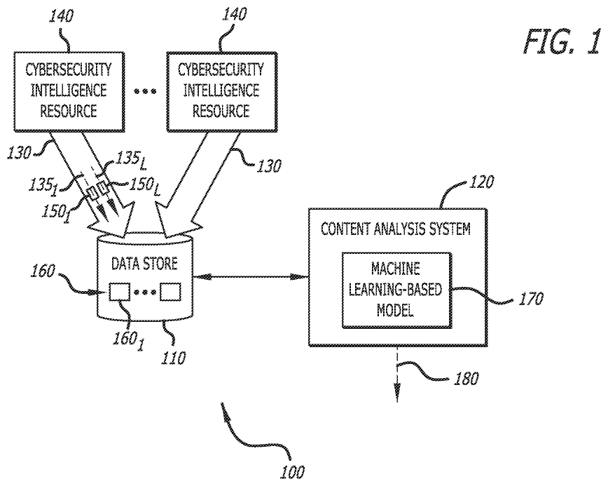

Referring to FIG. 1, a block diagram of an exemplary embodiment of a cyberthreat actor identification platform (hereinafter, “platform”) 100 is shown. Herein, the platform 100 includes at least a data store 110 and a cyberthreat analysis system 120 that is communicatively coupled to the data store 110. The data store 110 is configured to receive cybersecurity intelligence 130 from one or more cybersecurity intelligence resources (“resources”) 140. The cybersecurity intelligence 130 includes a plurality of cybersecurity intelligence clusters 135₁-135_{L} (L≥2), where each cybersecurity intelligence cluster 135₁-135_{L} may be a collection of intelligence associated with one or more investigations directed toward a particular cyberthreat. For example, a first cybersecurity intelligence cluster 135₁ may be an accumulation of evidence acquired from multiple investigations of a cyberthreat campaign or from a single investigation for example. Alternatively, the first cybersecurity intelligence cluster 135₁ may be information acquired from one or more prior analyses of malware or information associated with review of the current threat landscape as offered by cybersecurity investigators, such as observed campaigns or current cyberattack trends for example.

Each cybersecurity intelligence cluster 135₁ . . . or 135_{L} may be represented by certain forensically-related indicia 150₁ . . . or 150_{L} contained therein. For this embodiment of the disclosure, the forensically-related indicia 150₁ may constitute salient information from a cybersecurity intelligence cluster 135₁, where each indicium of the forensically-related indicia 150₁ pertains to one of a plurality of content types (categories). A structured representation of the forensically-related indicia 150 (e.g., indicia 150₁) associated with a cybersecurity intelligence cluster 135 (e.g., cluster 135₁) may be referred to as a “profile” 160 (e.g., profile 160₁).

As further shown in FIG. 1, according to one embodiment of the disclosure, the cyberthreat analysis system 120 is configured to generate and/or utilize a machine learning-based model 170. The model 170 is adapted to receive a form of cybersecurity intelligence and provide results 180 based on running the cybersecurity intelligence through the model 170. According to one embodiment of the disclosure, the results may be represented as (i) an organized grouping (i.e. listing) of profiles that are sorted based on levels of correlation (i.e., similarity metrics) computed between a reference profile and the listed profiles, (ii) a listing of profiles that are sorted based on highest levels of correlation with a reference profile, or the like.

### B. Cyberthreat Data Store

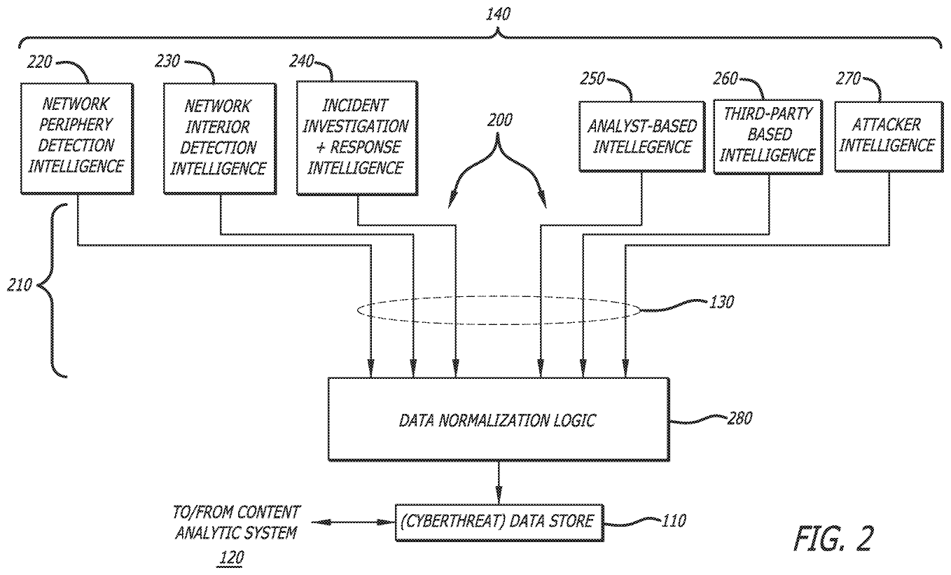

Referring now to FIG. 2, an exemplary block diagram of the data store 110 communicatively coupled to the cybersecurity intelligence resources 140 of FIG. 1 is shown. For this embodiment of the disclosure, the cybersecurity intelligence resources 140 may supply cybersecurity intelligence 130 from various locations over transmission medium 200 forming a wired or wireless network 210. Delivered by the cybersecurity intelligence resources 140 using a push and/or pull communication schemes, the cybersecurity intelligence 130 may include, but is not limited or restricted to one or more of the following: (a) network periphery detection intelligence 220, (b) network interior detection intelligence 230, (c) incident investigation/response intelligence 240, (d) analyst-based intelligence 250, (c) third-party based intelligence 260, and/or (f) attacker intelligence 270. Given that different the cybersecurity intelligence 130 may have a different formats, data normalization logic 280 is interposed between the cybersecurity intelligence resources 140 and the data store 110 to generate a standardized format for the cybersecurity intelligence 130 prior to storage within the data store 110.

More specifically, the cybersecurity intelligence 130 corresponds to malware analytics or information collected for such malware analytics. For instance, the network periphery detection intelligence 220 includes cybersecurity intelligence gathered from analyses of network traffic received by an appliance, a firewall or other network devices to detect certain types of cyberthreats, namely malicious intrusions, into a protected network. This intelligence 220 may include Uniform Resource Locators (URLs) associated with malicious email or other components and/or meta-information extracted from the network traffic. The network interior detection intelligence 230 includes cybersecurity intelligence gathered from analyses of information by network devices connected within the network after passing the periphery (e.g., software agents within endpoints, email servers, etc.) in order to detect and gather meta-information associated with cyberthreats, such as malicious operations, being attempted on network devices within the network itself.

The incident investigation/response intelligence 240 includes cybersecurity intelligence gathered by cyberattack incident investigators during analyses of successful cyberattacks. This type of cybersecurity intelligence tends to identify the nature and source of a detected cyberthreat, such as the following: name/alias of malware associated with the cyberthreat; how the malware gained entry on the network; target or targets of the cyberattack by company name, industry and/or location; and/or any remediation attempts conducted and the results of any attempts.

As further shown in FIG. 2, the analyst-based intelligence 250 includes cybersecurity intelligence gathered by highly-trained cybersecurity analysts, who analyze the detected malware to produce meta-information directed to its structure and code features. The third-party based intelligence 260 includes cybersecurity intelligence gathered from reporting agencies and other cybersecurity providers, which may be company, industry or government centric. Lastly, the attacker intelligence 270 includes cybersecurity intelligence gathered on known cyberthreat actor groups that is responsible (e.g., initiated) or is actively involved in the cyberthreat. Such cybersecurity intelligence may be directed as to whom are the attackers (e.g., name, location, etc.), whether state-sponsored attackers as well as common tools, technique and procedures used by a particular attacker that provide a better understanding the typical intent of the cyberthreat actor group (e.g., product disruption, financial information exfiltration, etc.), and the general severity of cyberthreats initiated by a particular attacker.

Collectively, some or all of these types of cybersecurity intelligence 130 may be stored and organized within the data store 110 in which each of the profiles 160 is representative of the cyberthreat associated with a cluster of each particular type of cybersecurity intelligence or perhaps multiple clusters of the same or different types of cybersecurity intelligence.

### III. Profile

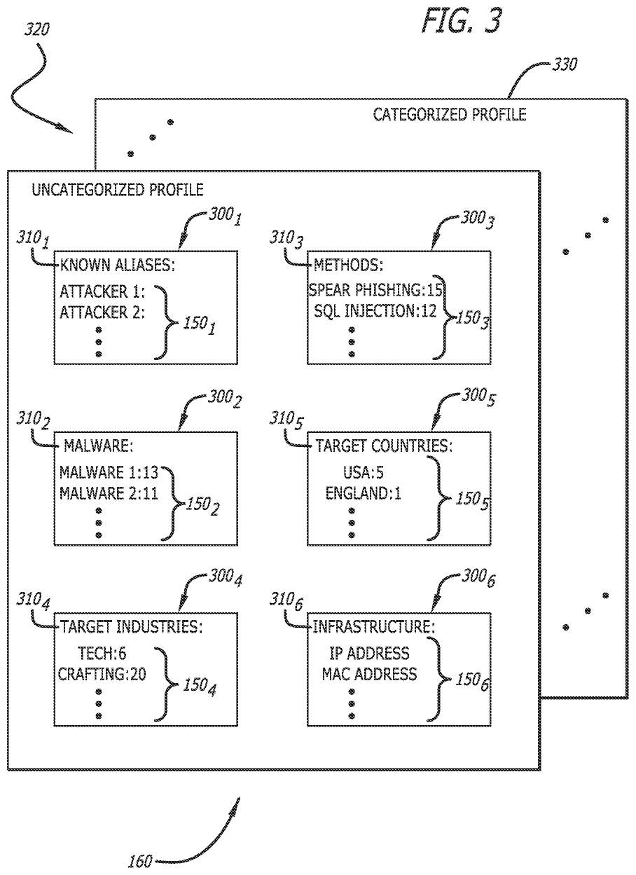

Referring to FIG. 3, an exemplary block diagram of an exemplary data structure utilized for profiles maintained within the data store 110 of FIG. 1 is shown. Herein, each profile 160 is a structured representation of a cybersecurity intelligence cluster (e.g., cybersecurity intelligence cluster 135₁ of FIG. 1) associated with a particular cyberthreat. As the cybersecurity intelligence cluster 135₁ may include content associated with more than one investigations, where additional content is acquired over time during analyses of a cyberthreat campaign for example, the size of the cybersecurity intelligence cluster 135₁ may increase in size. Therefore, the profile 160 may be updated as more cybersecurity intelligence associated with the cyberthreat (e.g., a cyberattack, campaign, etc.) is detected.

According to one embodiment of the disclosure, the profile 160 may be configured with a plurality of logical storage regions 300₁-300_{N} (N≥1, e.g., N=6), where each logical storage region 300₁-300₆ is responsible for maintaining a specific type (category) of forensically-related indicia therein. More specifically, for this embodiment of the profile 160, the forensically-related indicia 150₁ . . . or 150₆ may be maintained within logical storage regions 300₁-300₆, each corresponding to a particular category 310₁-310₆, respectively. The frequency of occurrences of certain indicium within the cybersecurity intelligence cluster 135₁ (e.g., counts) may be maintained in the logical storage regions 300₁-300₆ as well.

As further shown in FIG. 3, the categories for each profile 160 may be static, where these particular categories 310₁-310₆ are determined by analysts as particular types of content that tend to provide assistance in identifying a cyberthreat actor group responsible for a cyberthreat. For this illustrative embodiment of the profile 160, the indicia 150₁ . . . or 150₆ may include tactic, technique, and procedure (“TTP”) information, and thus, the profile 160 may be structured to support the indicia 150₁ . . . and/or 150₆ pertaining a plurality of categories 310₁ . . . and/or 310₆. The categories 310₁-310₆ may include, but are not limited or restricted to the following: (i) known aliases 310₁ (e.g., alias “attacker1,” “attacker 2,” etc.); (ii) malware names 310₂, (iii) methods 310₃ of installation and/or operation for the malware (e.g., spearfishing, powershell, etc.), (iv) targeted industries 310₄ (e.g., energy, semiconductor, etc.), (v) targeted countries 310₅ (e.g., United States, England, France, etc.), or (vi) infrastructure 310₆ (e.g., communicative information such as Internet Protocol “IP” address, Media Access Control “MAC” address, host address, etc.).

A corpus of profiles 320, including the profile 160, is maintained for each of the cybersecurity intelligence clusters. A profile within the corpus of profiles 320 (e.g., profile 160) may be labeled “uncategorized” (UNC) when its cyberthreat actor group has not been confirmed for that profile 160. Alternatively, a profile within the corpus of profiles 320 (e.g., profile 330) may be labeled with a designation for that known cyberthreat actor group when confirmed for that profile 330 (referred to as “categorized” profile). For this embodiment, the label may include an alphanumeric identifier to identify the known cyberthreat actor group.

### IV. Cyberthreat Analysis System

### A. Operational Flow for Model Generation/Application

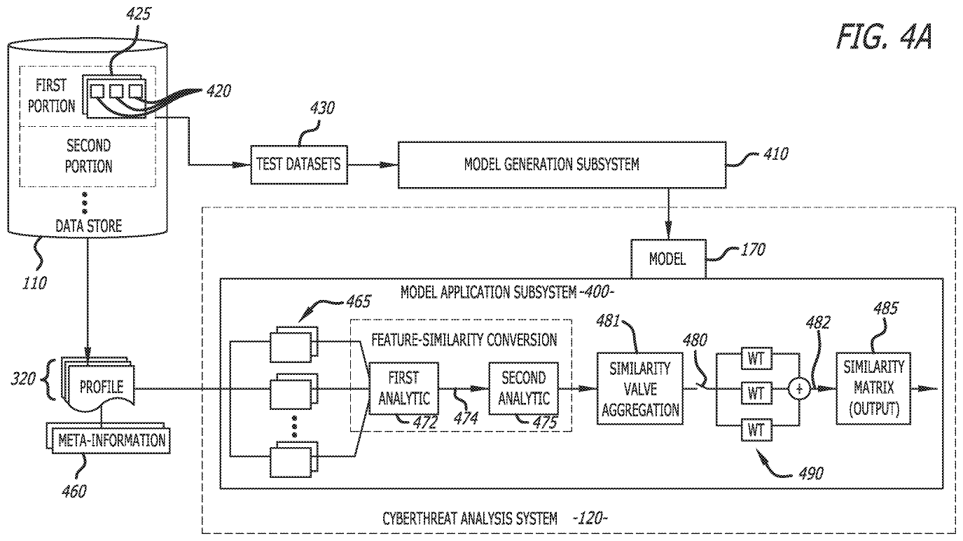

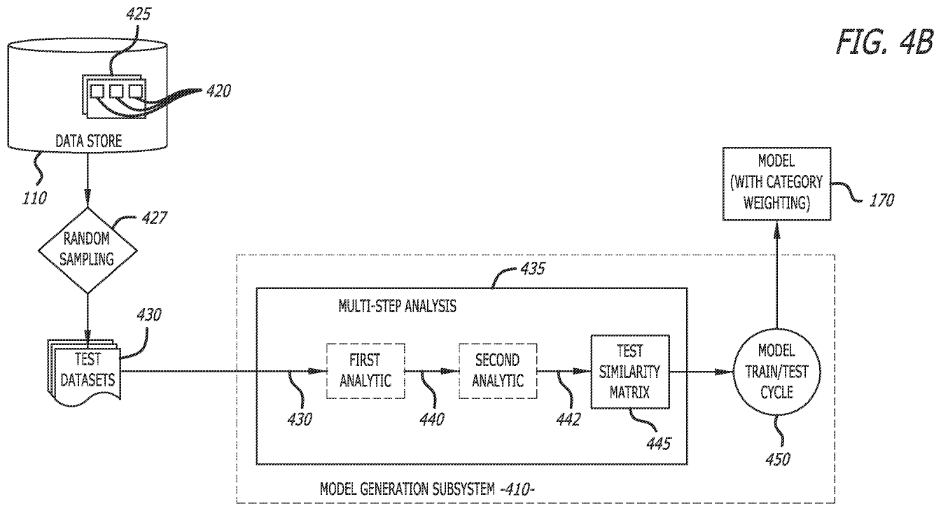

Referring to now FIG. 4A, an exemplary block diagram of the operational flow for model generation and usage by the cyberthreat analysis system 120 of FIG. 1 is shown. For this embodiment of the disclosure, the cyberthreat analysis system 120 includes a model application subsystem 400, which is communicatively coupled to a model generation subsystem 410. Herein, the model application subsystem 400 may be deployed within the cyberthreat analysis system 120 of FIG. 1. However, the model generation subsystem 410 may be deployed as part of the cyberthreat analysis system 120, or alternatively, the model generation subsystem 410 may be deployed separately from the cyberthreat analysis system 120, as shown. As an illustrative example, the model generation subsystem 410 may be implemented as a separate cloud service that generates and provides the machine learning-based model 170 to at least the cyberthreat analysis system 120. As another illustrative example, the model generation subsystem 410 may be implemented as a separate network device (e.g., web server(s), data transfer device, etc.) that is communicatively coupled with the cyberthreat analysis system 120 to provide the machine learning-based model 170 (and any updated thereto) to the model application subsystem 400.

As shown in FIGS. 4A-4B, according to this embodiment, the model generation subsystem 410 is configured to generate the model 170 based on a first portion of content 420 maintained within the data store 110. More specifically, as shown in FIG. 4A, the model generation subsystem 410 samples the first portion of content 420, namely forensically-related indicia sampled from multiple “categorized” profiles 425 stored within the data store 110. The sampling of the forensically-related indicia 420 may be randomized (operation 427) to produce a number of test profiles 430 from the forensically-related indicia 420, as shown in FIG. 4B. For instance, each test profile 430 may be a pair of indicium associated with the forensically-related indicia 420 that may pertain to (i) the same profile category but any of the “categorized” profiles 425 or (ii) any profile category from any of the “categorized” profiles.

Each of the test profiles 430 may undergo a multi-step analysis (see FIGS. 5A-5D) 435 that performs an initial conversion of the content of each test profile 430 into a pair of feature vectors 440, which are converted into a pair of similarity values 442 that operate as a similarity vector. Thereafter, similarity vectors for each and every pairwise combination of forensically-related indicia 420 from the categorized profiles 425 are aggregated to form a test similarity matrix 445.

The contents of the test similarity matrix 445 are made available to an interim model 450 for training (test cycles) to “learn” and ultimately produce the machine learning-based model 170. Stated differently, the machine learning-based model 170 may be “tuned” by the model generation subsystem 410 to improve operation by confirming that certain similarity vectors, based on portions of the forensically-related indicia 420 procured from a particular “categorized” profile, are determined by the model 170 to be correlated to that particular “categorized” profile. Thereafter, as a prescribed level of accuracy of the analytics conducted by the interim model 450 on the randomized test profiles 430 achieves a prescribed threshold, the resultant machine learning-based model 170 is provided to the model application subsystem 400.

Referring back to FIG. 4A, the model application subsystem 400 receives the machine learning-based model 170 generated by the model generation subsystem 410 and receives, as input, content associated with the stored corpus of profiles 320 along with meta-information 460 associated with each profile (e.g., profile identifier, etc.) from the data store 110. The stored corpus of profiles 320 may include forensically-related indicia associated with “categorized” profiles that represent identified cyberthreat actor groups and/or “uncategorized” profiles that represent unidentified cyberthreat actor groups, as described above and illustrated in FIG. 3. The model application subsystem 400 receives the content associated with the corpus of profiles 320 and, as an optional capability, may aggregate the content (and update count values) within multiple (two or more) profiles of corpus of profiles 320 in the event that these multiple profiles (and corresponding cyberthreats) are associated with the same or related cyberthreat actor group.

After content aggregation, the model application subsystem 400 parses the content from each of the profiles 320 on a per-category basis in order to generate a plurality of feature groupings 465. Each of the feature groupings 465 is a collection of indicia that is associated with a particular category. Hence, where the corpus of profiles 320 contains “L” profiles with “N” categories, the model application subsystem 400 generates L×N feature groupings 465. Each of the feature groupings 465 may undergo feature-similarity conversion 470 and linear weighting 490 into a format recognized by the machine learning-based model 170.

The feature-similarity conversion 470 constitutes a multi-step analysis on content within the profiles 320 to determine levels of correlation between the cybersecurity intelligence clusters associated with each of these profiles 320. A first analytic 472 is conducted on indicia maintained in each category of each profile to produce feature vectors 474. Each feature vector 474 is configured to represent the distinctiveness of indicium within its category for a particular profile. For instance, as an illustrative example, the first analytic 472 may convert each indicium (e.g., term) within each category of each profile into a value, which represents the distinctiveness of that indicium within its category as well as across the entire corpus of profiles 320 accessible to the model application subsystem 400.

Collectively, where a category of the profile has a total of “M” distinct indicium (where M≥1), the M-dimensional feature vector 474 for that category-profile combination is produced. For processing, the dimensions of the feature vectors may be uniform, where different dimensions may be associated with different types of indicium. The first analytic 472 is repetitive for each category within the corpus of profile 320 so that a feature vector is generated for each category of each profile.

Thereafter, a second analytic 475 of the multi-step analysis is conducted among different feature vectors 474 with each category. The second analytic 475 is conducted to determine a level of correlation (similarity value) between categories of different profiles, such as the first profile and any other categorized or uncategorized profiles within the stored corpus of profiles 320 for example. This “similarity value” may be represented by a value within a second prescribed range, where a higher value within the second prescribed range represents a higher correlation between features maintained within a specific category. Following the second analytic 475, similarity vectors 480 are generated from the similarity values (i.e., each vector 480 is a collection of multiple similarity values for each profile within the corpus of profiles 320).

Thereafter, each the similarity vector 480 may be translated into a similarity metric 482 (e.g., a single value associated with a comparison between two cybersecurity intelligence clusters), where similarity metrics associated with different cybersecurity intelligence cluster comparisons are aggregated to form a similarity matrix 485. The similarity matrix 485 allows an analyst to accurately determine, in real-time, the similarity between a reference profile (e.g., the first profile) and one of more other profiles within the corpus of profiles 320. Moreover, the similarity matrix 485 represents levels of correlation between cyberthreat actor groups that are responsible for the cybersecurity intelligence clusters associated with these profiles. To improve performance, the linear weighting 490 (e.g., each weighting<1 and total linear weighting=1), may be applied to some or all of the similarity metrics 482 forming the similarity matrix 485. The weighting is conducted to alter the relevance of certain indicia categories in identifying cyberthreat actor group responsibility based on changes in the threat landscape. Also, by maintaining the results from the first analytic 472 and the second analytic 475, the model application subsystem 400 may provide virtualization as to the level of correlation between features within the profiles being compared as evidence for the conclusions reached by the machine learning-based model 170.

### A. Logical Architecture for Model Generation/Application

Referring to FIG. 5A, a first exemplary block diagram of the logical architecture of the cyberthreat analysis system 120 of FIG. 1 is shown. According to one embodiment of the disclosure, the cyberthreat analysis system 120 includes a processor 500, a network/user interface 505 to receive cybersecurity intelligence and other information (e.g., logic or model updates if model generation subsystem 410 is located remotely, etc.), and a memory 510, which is configured to store logic 520 for execution by the processor 500. Examples of the stored logic 520 may include, but is not limited or restricted to model application subsystem 400, optional model generation subsystem 410 (as represented by dashed lines), and reporting logic 580. The model application subsystem 400 further includes content aggregation logic 530, cyberthreat analytic logic 540 and model optimization logic 550, as described below. The logic may be physical devices or virtual devices (e.g., virtual compute engines, virtual memory, etc.). The logical interoperability between the subsystems and logic is illustrated in FIG. 5B.

Referring now to FIG. 5B, according to this embodiment of the disclosure, the model generation subsystem 410 is configured to generate machine learning-based model 170, which is configured to evaluate similarities between profiles, each representative of a received cybersecurity intelligence cluster, in efforts to identify and merge cybersecurity intelligence clusters associated with cyberthreats from the same or related cyberthreat actor group. In particular, for this embodiment, the model 170 may be created by converting content within the corpus of profiles 320 into the similarity matrix that includes pre-determined comparisons between any profiles within the corpus of profiles.

More specifically, for this embodiment, the model generation subsystem 410 is configured to generate the machine learning-based model 170 by at least analyzing the contents of the data store 110. In some embodiments, the model generation subsystem 400 accesses the first portion of content 420 maintained within the data store 110 to generate the model 170, and optionally, a second portion of content 422 contained within the data store 110 to verify the model 170.

The model application subsystem 400 receives the model 170 generated by the model generation subsystem and applies the corpus of profiles 320, including the content associated with the “categorized” and “uncategorized profiles. In particular, the content aggregation logic 530 of the model application subsystem 400 is configured to access information regarding the corpus of profiles 320 (e.g., forensically-related indicia maintained in “categorized” profiles and “uncategorized” profiles) and separate forensically-related indicia associated with each category of the profiles for subsequent processing by the cyberthreat analytic logic. As a result, where each profile is segmented into “N” categories (N≥1, e.g., N=4, 5 or 6), the content aggregation logic 530 produces “N” feature groupings 465 of forensically-related indicia, where each of the feature groupings 465 corresponding to a particular category.

Thereafter, the cyberthreat analytic logic 540 is configured to conduct the multi-step analysis on content associated with the feature groupings 465 to determine levels of correlation between the cybersecurity intelligence clusters associated with each of these profiles 320. The multi-step analysis involves a first analytic 472 that is conducted on content within the feature groupings 465, namely the forensically-related indicia associated with the “N” categories, to produce “N” feature vectors 474. Each feature vector 474 includes a value 545 associated with each feature within that profile category.

According to one embodiment of the disclosure, as shown in FIG. 5C, each value 545 is generated based on a Term Frequency-Inverse Document Frequency (TF-IDF) conversion technique 550 that determines which indicia is more influential in determining a cyberthreat actor group than other indicia.

The TF-IDF conversion technique 550 includes two operations to compute a level of distinctiveness associated with salient information within each cybersecurity intelligence cluster that is represented by forensically-related indicia within the profiles. The first (TF) operation 555 generates a first (TF) value 557 that represents a ratio between (i) how often (count) particular indicium (e.g., term) appeared within content of a profile under analysis and (ii) a total number of all indicia (e.g., terms) within that profile. The second (IDF) operation 560 computes a second (IDF) value 565 of how frequently the particular indicium (e.g., term) appears across all of the profiles. The second (IDF) value 565 is a result produced from a natural logarithmic operation being conducted on a ratio between the total number of profiles within the corpus of profiles and the number of profiles including the particular indicium. As evident by the illustrative graph 570, when the ratio is close to “1” (i.e. very common terms), the logarithmic operation sets the second (IDF) value 565 near-zero, thus down-weighting the value 545 being a product of the first (TF) value 557 and the second (IDF) value 565 (TF×IDF value). Hence, the presence of a much higher second (IDF) value will result in a higher value 545. The values for each indicium within each category for each profile are aggregated to form feature vectors 474 for each category within each profile, as shown in FIG. 5B.

Referring back to FIG. 5B, the cyberthreat analytic logic 540 is further configured to conduct the second analytic 475 on combinations of feature vectors 474 to determine the difference between cyberthreat actor groups. In some embodiments, feature vector similarity may be determined using, for example, a Cosine Similarity technique 575 as shown in FIG. 5D. The Cosine Similarity technique 575 may be used to evaluate a level of correlation (similarity) of each of the profiles (e.g., first profile “P1” and second profile “P2”) by plotting the feature vectors 577 and 579 representative of the cyberthreat. Where the vectors are directed in the same direction (e.g., in parallel), the compared profiles (P1, P2) may be highly correlated. The greater degree of angular offset (θ) from the parallel direction indicates a corresponding diminishing level of correlation (similarity). The level of correlation may be represented by a particular score (i.e., similarity value) within the second prescribed range, where a similarity value towards the ends of this range identifies higher/lower levels of correlation (increased/decreased similarity).

It is contemplated that FIG. 5D illustrates only two of the dozens or hundreds of dimensions, which are used to calculate cosine similarity. Two dimensions are used in this case to allow it to be easily plotted for human viewing. In the example, two Groups are represented by a vector composed of their TF-IDF values for a first indicium (term 1) along an x-axis and a second indicium (term 2) along the y-axis. The cosine value of the angle (θ) between these terms serves as our similarity value. This can also interpreted as a measure of ‘how parallel’ the two vectors are in this space. In reality we perform this evaluation for all groups, across all terms within each category, and thus arrive as cosine similarity values for each category and each pair of groups in the corpus.

As shown in FIG. 5B, using TF-IDF and Cosine Similarity described above, category-specific similarities (i.e., similarity values) for every combination of profiles within the corpus of profiles. Furthermore, cyberthreat analytic logic 540 may be configured to combine these similarity values associated with category comparisons of a particular profile combination to form a similarity vector 480. The similarity vector 480 may be subsequently used in determining, in real-time, a level of correlation between an identified, cyberthreat actor group associated with a reference profile and one or more cyberthreat actor groups among a corpus of profiles.

As further shown in FIG. 5B, the model optimization logic 550 is configured to convert the similarity vectors 480 into the similarity matrix 485, as described above. According to one embodiment of the disclosure, the model optimization logic 550 may apply a linear weighting of each of the similarity values, without changes to other model functionality, where an operation on the weighted similarity values (e.g., arithmetic operation such as addition) produces a similarity metric associated with a profile comparison. The similarity metrics, generated by weighting and arithmetic operations on the similarity values forming similarity vectors 480 for all profile combinations (e.g., similarity metric=weighting1*(similarity value for malware category+weighting2*(similarity value for targeted industry category+ . . . ), are aggregated as the similarity matrix 485. For a query message 590 (request for a sorting listing of profiles similar to a reference profile) and a merge message 592 (request for a sorted listing of the most common profile pairs), the similarity matrix 485 is accessed and the results are sorted and return to a requesting user for display via interface 595.

Herein, the similarity computations based on TF-IDF and Cosine Similarity are merely illustrative of computations to compute category-specific similarities, as described above. It is contemplated that other approaches may be employed to compute determine the similarity of cybersecurity intelligence.

The reporting logic 580 receives from information associated with merged profiles associated with known and/or unknown cyberthreat actor groups for further investigation by cyberthreat analysts and/or for alerting cybersecurity investigators of such findings. In some embodiments, cybersecurity investigators may receive reports 585, such as displayable or printable listing, charts, graphs for example, which may include information associated with newly merged cyberthreat actor groups to access network and system vulnerability associated with that cyberthreat actor group. Also, the reports may provide for automated remediation by selection of a displayable object, which associates a cybersecurity actors and halts (temporarily or permanently) communications with an originating source of the cybersecurity intelligence.

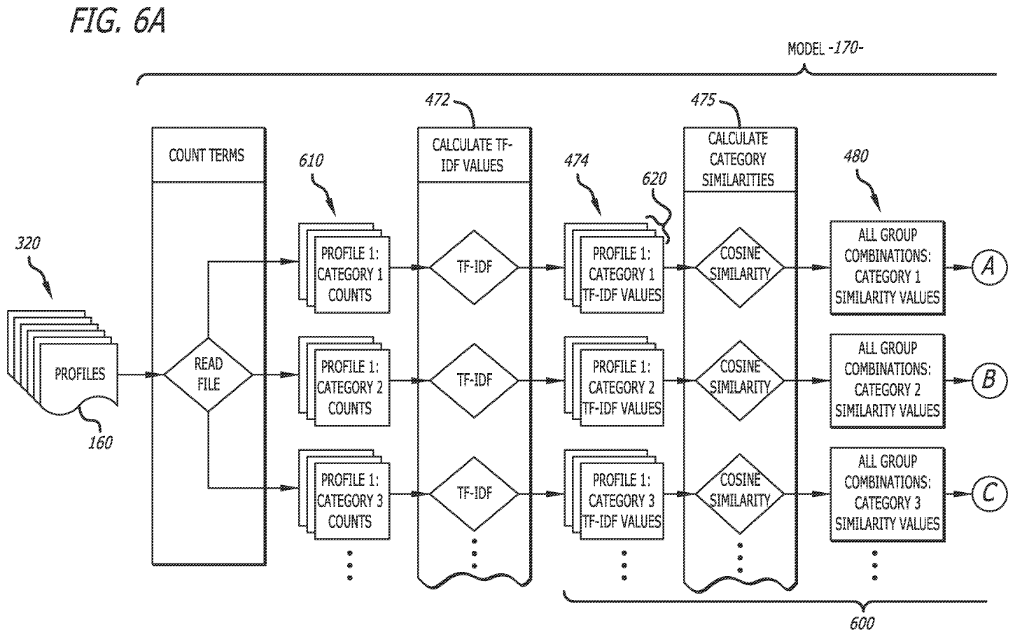

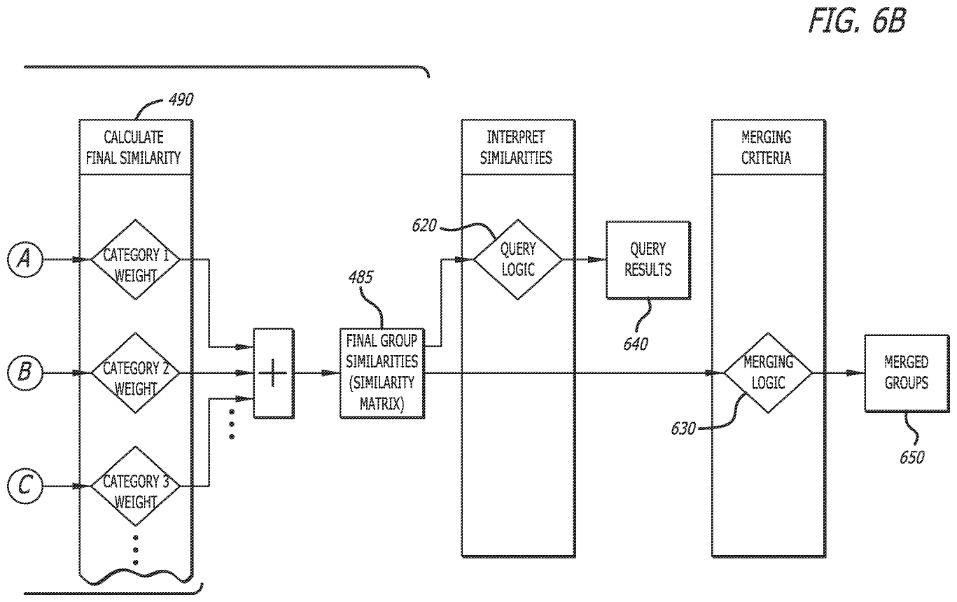

Referring now to FIGS. 6A-6B, exemplary block diagrams of an operational flow of the cyberthreat analysis system 120 of FIG. 5A are shown. According to one embodiment of the disclosure, as shown in FIG. 6A in response to a triggering event (e.g., time-based trigger, change in a profile or predetermined number or percentage of profiles, etc.), the machine learning-based model 170 may be updated by conducting analytics on the indicia included within the any selected profile or a combination of profiles in order to uncover connections between a cyberthreat actor group responsible for a particular cyberthreat or a new of existing cyberthreat actor group being responsible for multiple cyberthreats. Although, as an alternative embodiment, the machine learning-based model 170 may be configured to conduct analytics on a collection of data larger than the profiles 320.

Although not shown, cybersecurity intelligence may be received from one or more network devices and stored within the data store 110 of FIG. 1. The profile 160 may be generated to maintain forensically-related indicia associated with each cybersecurity intelligence cluster and the number of occurrences of each indicium. The categories for indicia to be included in the corpus of profiles 320 are determined by analysts.

As shown in FIG. 6A, operating in accordance with the machine learning-based model 170, the cyberthreat analysis system conducts a multi-step analysis 600 on content within the profiles 320 to determine levels of correlation between the cybersecurity intelligence clusters associated with each of these profiles. The multi-step analysis 600 may be conducted to identify profiles within the corpus of profiles 320 that have similar indicia and/or a determined a level of correlation, and as a result, identifies the cyberthreats represented by these profiles 320 may have been perpetuated by the same cyberthreat actor group or related cyberthreat actor groups.

For this embodiment of the disclosure, the multi-step analysis 600 involves the first analytic 472 conducted on indicia 610 maintained in each profile category to produce feature vectors 474 for each category. Each feature vector 474 is configured to represent the distinctiveness of indicium within its category. More specifically, the results of the first analytic form a feature vector for each category (e.g., Unclassified_Malware1=<0.23, 0.013, 0045, . . . >).

Additionally, the second analytic 475 of the multi-step analysis 600 is conducted between the feature vectors 474 associated with each category of the first profile to feature vectors associated with corresponding categories from the other profiles within the corpus of profiles, which may include other “categorized” profiles and/or “uncategorized profiles 620. The second analytic 475 is conducted to determine a level of correlation (similarity value) between categories of different profiles, such as the first profile and any categorized or uncategorized profiles within the stored corpus of profiles. This “similarity value” may be represented by a value within a second prescribed range, where a higher value within the second prescribed range represents a higher correlation between features maintained within a specific category. The second analytic 475 is further configured to generate a similarity vector 480 (i.e., a collection of multiple similarity values between the first profile and another profile within the corpus of profiles).

Thereafter, the similarity vector 480 may be translated into a similarity metric, where operations are conducted iteratively for all of the profiles to form the similarity matrix 485, which allows an analyst to accurately determine, in real-time, the similarity between a reference profile (e.g., the first profile) and one of more other profiles within the corpus of profiles. According to one embodiment of the disclosure, this translation from the similarity vector 480 to a similarity metric may include conducting a weighted arithmetic operations on the similarity values within the similarity vector 480 as described above. Moreover, the similarity matrix 485 represents levels of correlation between cyberthreat actor groups that are responsible for the cybersecurity intelligence clusters associated with these profiles.

As shown in FIG. 6B, to improve performance, the linear weighting 490 may be applied to some or all of the similarity metrics forming the “similarity matrix.” The weighting 490 is conducted to alter the relevance of certain indicia categories in identifying cyberthreat actor group responsibility based on changes in the threat landscape. Also, by maintaining the results from the first and second analytics 472 and 474, the cyberthreat analysis system 120 may provide visibility as to the level of correlation between features within the profiles 320 being compared as evidence for the conclusions reached by the machine learning-based model 170.

Responsive to a query message 620 (request for a sorting listing of profiles similar to a reference profile) or a merge message 630 (request for a sorted listing of the most common profile pairs), the similarity matrix 485 is accessed and the results 640 and 650, respectively. The results 640 and 650 may be sorted and returned for display and review by a cybersecurity investigator.

In the foregoing description, the invention is described with reference to specific exemplary embodiments thereof. As described above, cybersecurity intelligence reports are associated with each other to generate cybersecurity intelligence clusters, which may be assigned to known or unknown cyberthreat actor groups based on analyst conclusions. Herein, in some instances, certain uncategorized cybersecurity intelligence clusters (clusters assigned with an unknown cyberthreat actor group) may be automatically assigned to a particular known cyberthreat actor group based on the model described above. However, it will be evident that various modifications and changes may be made thereto without departing from the broader spirit and scope of the invention as set forth in the appended claims.

What is claimed is:

1. A computerized method for associating cyberthreat actor groups responsible for different cyberthreats, comprising:
receiving, by a computing system comprising one or more computing devices, a plurality of clusters of cybersecurity information respectively associated with a plurality of cyberthreats;
generating, by the computing system, a plurality of feature vectors respectively for the plurality of clusters of cybersecurity information;
processing, by the computing system, the plurality of feature vectors with a machine-learned model to generate one or more similarity metrics, wherein each of the one or more similarity metrics describes a similarity between two of the plurality of clusters of cybersecurity information; and
associating, by the computing system, at least a first cluster of the clusters of cybersecurity information with a particular cyberthreat actor group based at least in part on the one or more similarity metrics.

2. The method of claim 1, wherein generating the respective feature vector for each of the clusters of cybersecurity information comprises:
extracting a respective set of forensically-related indicia from each of the clusters of cybersecurity information; and
generating the respective feature vector for each cluster of cybersecurity information from the set of forensically-related indicia associated with the cluster of cybersecurity information.

3. The method of claim 2, wherein at least one indicium in at least one of the sets of forensically-related indicia comprises a frequency of occurrence of a type of content within the cluster of cybersecurity information.

4. The method of claim 3, wherein the type of content comprises one or more of the following: (i) known aliases, (ii) malware names, (iii) methods of installation and/or operation for the malware, (iv) targeted industries, (v) targeted countries, or (vi) infrastructure.

5. The method of claim 1, wherein processing, by the computing system, the plurality of feature vectors with a machine-learned model to generate one or more similarity metrics comprises determining, by the computing system, a cosine similarity between two of the plurality of feature vectors.

6. The method of claim 1, wherein the machine-learned model applies a plurality of learned weight values to generate the one or more similarity metrics.

7. The method of claim 1, wherein associating, by the computing system, at least the first cluster of the clusters of cybersecurity information with the particular cyberthreat actor group based at least in part on the one or more similarity metrics comprises merging, by the computing system, the first cluster with a second cluster of the clusters of cybersecurity information based on the one or more similarity metrics between the first cluster and the second cluster, and wherein the second cluster has previously been associated with the particular cyberthreat actor group.

8. The method of claim 1, wherein the machine-learned model has been trained to generate similarity vectors that correlate cybersecurity data to a pre-categorized profile.

9. A computing system for associating cyberthreat actor groups responsible for different cyberthreats, the computing system comprising:
one or more processors; and
one or more non-transitory computer-readable media that store:
a machine-learned model; and
computer-executable instructions for performing operations, the operations comprising:
receiving, by the computing system, a plurality of clusters of cybersecurity information respectively associated with a plurality of cyberthreats;
generating, by the computing system, a plurality of feature vectors respectively for the plurality of clusters of cybersecurity information;
processing, by the computing system, the plurality of feature vectors with the machine-learned model to generate one or more similarity metrics, wherein each of the one or more similarity metrics describes a similarity between two of the plurality of clusters of cybersecurity information; and
associating, by the computing system, at least a first cluster of the clusters of cybersecurity information with a particular cyberthreat actor group based at least in part on the one or more similarity metrics.

10. The computing system of claim 9, wherein generating the respective feature vector for each of the clusters of cybersecurity information comprises:
extracting a respective set of forensically-related indicia from each of the clusters of cybersecurity information; and
generating the respective feature vector for each cluster of cybersecurity information from the set of forensically-related indicia associated with the cluster of cybersecurity information.

11. The computing system of claim 10, wherein at least one indicium in at least one of the sets of forensically-related indicia comprises a frequency of occurrence of a type of content within the cluster of cybersecurity information.

12. The computing system of claim 11, wherein the type of content comprises one or more of the following: (i) known aliases, (ii) malware names, (iii) methods of installation and/or operation for the malware, (iv) targeted industries, (v) targeted countries, or (vi) infrastructure.

13. The computing system of claim 9, wherein processing, by the computing system, the plurality of feature vectors with a machine-learned model to generate one or more similarity metrics comprises determining, by the computing system, a cosine similarity between two of the plurality of feature vectors.

14. The computing system of claim 9, wherein the machine-learned model applies a plurality of learned weight values to generate the one or more similarity metrics.

15. The computing system of claim 9, wherein associating, by the computing system, at least the first cluster of the clusters of cybersecurity information with the particular cyberthreat actor group based at least in part on the one or more similarity metrics comprises merging, by the computing system, the first cluster with a second cluster of the clusters of cybersecurity information based on the one or more similarity metrics between the first cluster and the second cluster, and wherein the second cluster has previously been associated with the particular cyberthreat actor group.

16. The computing system of claim 9, wherein the machine-learned model has been trained to generate similarity vectors that correlate cybersecurity data to a pre-categorized profile.

17. One or more non-transitory computer-readable media that store:
a machine-learned model; and
computer-executable instructions for performing operations, the operations comprising:
receiving, by a computing system, a plurality of clusters of cybersecurity information respectively associated with a plurality of cyberthreats;
generating, by the computing system, a plurality of feature vectors respectively for the plurality of clusters of cybersecurity information;
processing, by the computing system, the plurality of feature vectors with the machine-learned model to generate one or more similarity metrics, wherein each of the one or more similarity metrics describes a similarity between two of the plurality of clusters of cybersecurity information; and
associating, by the computing system, at least a first cluster of the clusters of cybersecurity information with a particular cyberthreat actor group based at least in part on the one or more similarity metrics.

18. The one or more non-transitory computer-readable media of claim 17, wherein generating the respective feature vector for each of the clusters of cybersecurity information comprises:
extracting a respective set of forensically-related indicia from each of the clusters of cybersecurity information; and
generating the respective feature vector for each cluster of cybersecurity information from the set of forensically-related indicia associated with the cluster of cybersecurity information.

19. The one or more non-transitory computer-readable media of claim 18, wherein at least one indicium in at least one of the sets of forensically-related indicia comprises a frequency of occurrence of a type of content within the cluster of cybersecurity information.

20. The one or more non-transitory computer-readable media of claim 17, wherein processing, by the computing system, the plurality of feature vectors with a machine-learned model to generate one or more similarity metrics comprises determining, by the computing system, a cosine similarity between two of the plurality of feature vectors.
